(19) United States
(12) Patent Application Publication
(10) Pub. No.: US 2025/0383489 A1
(43) Pub. Date: Dec. 18, 2025

(54) WAVEGUIDE LENS

(71) Applicant: Christian Wöhler, Heidelberg (DE)

(72) Inventor: Christian Wöhler, Heidelberg (DE)

(21) Appl. No.: 19/142,003

(22) PCT Filed: Dec. 18, 2023
(86) PCT No.: PCT/EP2023/086347

§ 371 Date: Jun. 20, 2025

Related U.S. Application Data
(60) Provisional application No. 63/476,963, filed on Dec. 23, 2022.

(51) Int. Cl. G02B 5/20

(52) U.S. Cl. CPC G02B 5/201

(57) ABSTRACT

Disclosed herein is a waveguide lens. The waveguide lens may comprise a layer of material (101) that is opaque to radiation. A plurality of apertures may be disposed in the layer. Each aperture (108) of the plurality of apertures may have geometric characteristics for controlling a phase of radiation propagating through the aperture. Each aperture (108) of the plurality of apertures in the layer may controls the phase of the radiation that emanates from a light emitter and propagates through the aperture, based on a location of the aperture in the layer, to form a predetermined interference pattern after the radiation has propagated through the aperture.

### BACKGROUND

A variety of different lenses may be used to shape light. To shape light, such lenses may use techniques including one or more of refraction, reflection, diffraction, and interference. However, the ability of such lenses to focus light may be limited by design constraints associated with the devices, such as the size, weight, and cost of the lens. Additionally, many materials have limitations that make them applicable to only a narrow range of wavelengths. Accordingly, improvements to allow for more sophisticated and flexible lens are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 shows an example system for focusing light using a waveguide lens, in accordance with various embodiments.

FIG. 2 shows an example waveguide lens, in accordance with various embodiments.

FIG. 3A shows example cross sections of a waveguide lens, in accordance with various embodiments.

FIG. 3B is a top view of a central portion of a waveguide lens, in accordance with various embodiments.

FIG. 4 is a flow diagram of an example method of manufacturing a waveguide lens, in accordance with various embodiments.

### DETAILED DESCRIPTION

Disclosed herein is a waveguide lens, as well as related methods and systems. For example, in some embodiments, the waveguide lens may comprise a plate that provides a plurality of apertures of a certain depth (e.g., waveguides) for letting radiation pass through the plate. The plurality of apertures may shape the phase of the radiation in a desired way inside the apertures so that the radiation interferes in a specific pattern. The interference pattern may be recorded by a sensor or may be further processed by additional optical elements. In some embodiments, the waveguide lens may focus coherent light emanating from a light emitter in a focus point. Coherent light may be defined as light of the same wavelength that comes from the same location. The light emitter may be located proximate to (e.g., in the order of the size of the plate) the waveguide lens. In some embodiments, the waveguide lens may focus coherent light emanating from infinity on one side of the waveguide lens to a focus point on the other side of the waveguide lens. In some embodiments, the plurality of apertures may comprise metal walls. The metal walls may be electrically conductive. The metal walls may comprise or may be made of silver, gold, copper, or aluminum. For example, in some embodiments, the plate may be made of a conductive material (e.g., metal), and apertures of different depths and/or different cross-sectional sizes may be etched or added to the plate.

Existing devices for focusing light include Fresnel zone plates and photon sieves, which are a further development of Fresnel zone plates. However, Fresnel zone plates and photon sieves may have a substantial area that is opaque to radiation. The area that is opaque to the radiation often includes a central portion of the Fresnel zone plate or the photon sieve.

By contrast, the phases of the radiation passing through each of the plurality of apertures of the waveguide lens described herein may be controlled (e.g., modified, changed, etc.) inside the plurality of apertures to optimize the interference of the radiation at the focus point. Controlling the phases of the radiation propagating through the apertures may, in some embodiments, comprise slowing down or freezing the spatial change of the phases of the radiation inside the apertures compared to the radiation in free space (i.e. in vacuum). A slowing down of the spatial change of the phases of the radiation may be understood as increasing the wavelength of the radiation and thus increasing the phase velocity of the radiation inside the apertures. A freezing of the spatial change of the phases of the radiation may be understood as increasing the wavelength so much that the wavelength is infinite and thus the phase velocity of the radiation inside the apertures is also infinite. In other words, a frozen spatial change of the phases of the radiation inside the apertures may mean that the radiation exits the apertures with the same phase with which the radiation has entered the apertures when the time dependence of the phase is disregarded. Each of the plurality of apertures may comprise geometric characteristics for controlling a phase of the radiation propagating through that particular aperture. Thus, the waveguides may not need to be arranged (e.g., positioned) in a specific manner in order to achieve constructive interference at a predetermined focus point. Rather, the waveguides may be arranged in any desired manner, and the geometric characteristics of each of the plurality of apertures may be controlled in order to achieve constructive interference at the predetermined focus point. The plurality of apertures may be located as close together on the plate as technically possible regarding fabrication of the waveguide lens, without requiring opaque areas of a certain size or shape. The ability to position the plurality of apertures closely together on the plate may increase the efficiency of the waveguide lens with respect to the amount of radiation that is used for the constructive interference and thus, may also improve the interference of the radiation at the focus point. In addition, the apertures may comprise a waveguide that controls the phase of radiation propagating through the aperture by increasing the phase velocity which is different to e.g. a phase Fresnel zone plate in which different rings may have different thicknesses of transparent material that reduces the phase velocity of radiation in the material compared the radiation in free space.

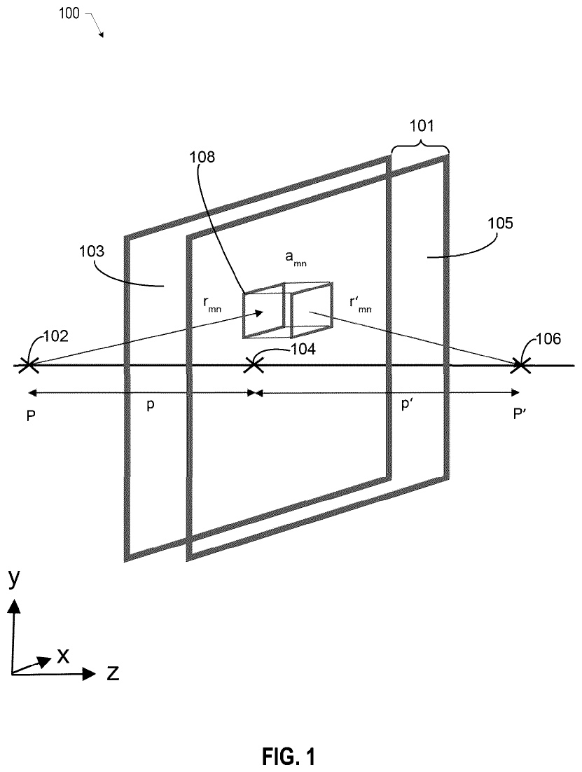

FIG. 1 shows an exemplary system 100 for focusing light using a waveguide lens. The waveguide lens may be configured to focus light from a light emitter such as point source 102 located at point P. The point P may be located at a distance p from a center 104 of the lens. The waveguide lens may be configured to focus the light at a focus point 106. The focus point 106 may be located at a point P′. The point P′ may be located at a distance p′ from the center 104 of the lens.

A waveguide lens may comprise a plurality of apertures formed in a layer of material that is opaque to radiation. The layer may be opaque to radiation that does not go through the apertures. Each of the plurality of apertures may have geometric characteristics for controlling a phase of radiation propagating through the aperture. The geometric characteristics may include a size of a cross section and a depth of each aperture of the plurality of apertures. The size of the cross section of each aperture may control or modify the wavelength of the radiation that propagates through the aperture (and thus the spatial phase change in the aperture) and the depth of each aperture may control how long the radiation propagates through the aperture. The plurality of apertures may include waveguides each of which having a size of a cross section that is configured to provide a cutoff frequency so that incident radiation with a frequency below the cutoff frequency is attenuated inside the aperture and incident radiation with a frequency above the cutoff frequency propagates through the aperture. Each of the plurality of apertures in the layer may control the phase of the radiation that emanates from a light emitter and propagates through the aperture. The phase of the radiation may be controlled inside each aperture based on a location of the aperture in the layer to form a predetermined interference pattern after the radiation has propagated through the aperture. In other words, the size of the cross section and the depth of each aperture may be configured to increase the phase velocity inside the aperture for a certain depth to compensate phase differences to radiation going through different apertures and generate a desired predetermined interference pattern. The predetermined interference pattern may be wavefronts that all interfere constructively in a focus point. In a different embodiment, the predetermined interference pattern may be plane waves that may be considered to have a focus point at infinity. In a further different embodiment, the predetermined interference pattern may be waves that resemble waves coming from a virtual point in front of the waveguide lens. In an embodiment, the predetermined interference pattern may compensate for further phase differences. The further phase differences may come e.g. from an angle dependent coupling of the radiation from the light emitter to the waveguide modes in which the radiation propagates through the apertures or an angle dependent coupling of the waveguide modes to the radiation mode assumed after leaving the aperture. The further phase differences may also come from optical elements that are placed before or behind the waveguide lens and that add undesired phase differences.

In FIG. 1, the predetermined interference pattern that is formed by the apertures in the layer 101 of the waveguide lens is the focused light at the focus point 106. The layer 101 may comprise a first surface 103 and a second surface 105. It should be understood that an aperture as disclosed herein does not require empty space. An aperture may include empty space or material positioned inside the aperture. The aperture may include any path configured to propagate at least a portion of the radiation through the layer 101. In the example of FIG. 1, an aperture 108, represented as aₘₙ of a plurality of apertures is located at position m, n (e.g., row m and column n). The aperture 108 may comprise a square cross section. The label rₘₙ may be the distance from the point source 102 to the aperture 108 and r′ₘₙ may be the distance from the aperture 108 to the focus point 106. It may be advantageous for the plurality of apertures to comprise square cross sections, as square cross sections do not depend on the polarization of the radiation from the point source 102 and because apertures having square cross sections may be positioned closely next to each other, thus reducing the space between them. While the aperture 108 of FIG. 1 is shown to have a square cross section, it should be appreciated that in other embodiments, the plurality of apertures may comprise other, non-square, cross sections, including circular cross sections (which also do not depend on the polarization of the radiation from the point source 102), rectangular cross sections, or hexagonal cross sections.

The path of the radiation propagating from the point source 102 to the focus point 106 may comprise three different portions (e.g., components). The first portion may comprise the path of the radiation propagating from the point source 102 to the opening of the aperture 108 on the source side (e.g., the ingoing opening of the aperture 108). The second portion may comprise the path of the radiation propagating from through the aperture 108 (e.g., inside the aperture 108). The third portion may comprise the path of the radiation propagating from the opening of the aperture 108 on the image side to the focus point 106 (e.g., from the outgoing opening of the aperture 108 to the focus point 106).

The contribution of the electric field of the radiation propagating along the path of the radiation propagating from the point source 102 to the focus point 106 may be estimated by the following formula:

$${E}_{mn} ( x , y , z , t ) = {E}_{0} \frac{{e}^{- i ω {t}_{1} + {ikr}_{mn}}}{2 π {r}_{mn}} {A}_{mn} {e}^{- i ω {t}_{2} + ik {φ}_{mn}} \frac{{ie}^{- i ω {t}_{3} + {ikr}_{mn}^{′}}}{2 π {r}_{mn}^{′}} k \times {\int }_{{S}_{mn}} n \times E ( {x}^{″} ) {e}^{- ik \cdot {x}^{″}} {da}^{″} \qquad Formula 1$$

$$where \frac{{e}^{- i ω {t}_{1} + {ikr}_{mn}}}{2 π {r}_{mn}}$$

(e.g., the first propagation part) represents the contribution of the electric field of the radiation propagating along the first portion of the path, Aₘₙe^{-iωt}^{₂}^{+ikφ}^{ₘₙ} (e.g., the second propagation part) represents the contribution of the electric field of the radiation propagating along the second portion of the path including the coupling, and

$$\frac{i {e}^{- i ω {t}_{3} + {ikr}_{mn}^{′}}}{2 π {r}_{mn}^{′}} k \times {\int }_{{S}_{mn}} n \times E ( {x}^{″} ) {e}^{- ik \cdot {x}^{″}} {da}^{″}$$

(e.g., the third propagation part) represents the contribution of the electric field of the radiation propagating along the third portion of the path, including coupling. The bolded letters represent a vector, a dot between vectors represents a vector dot product, and a cross represents a vector cross product. The time, t, is equal to the sum of the partial propagation times (e.g., t=t₁+t₂+t₆).

The first propagation part may be represented by the fraction

$$\frac{{e}^{- i ω {t}_{1} + {ikr}_{mn}}}{2 π {r}_{mn}} .$$

The fraction

$$\frac{{e}^{- i ω {t}_{1} + {ikr}_{mn}}}{2 π {r}_{mn}}$$

may describe a spherical wave from the point source 102 to the center of the aperture 108 at point (xₘₙ, yₘₙ, zₘₙ). The wave number k may be equal to k=2π/λ, with λ representing the wavelength of the radiation in a vacuum. If the light emitter at the point source 102 is inside some liquid or material, λ may represent the wavelength of the radiation in such liquid or material. The time t₁ may be the time the radiation takes to propagate from the point source 102 to the aperture 108.

The second propagation part may be described by Aₘₙe^{-ωt}^{₂}^{+ikφ}^{ₘₙ}, with Aₘₙ representing the coupling of the spherical wave to the waveguide mode, t₂ representing the time that the radiation takes to propagate through the aperture 108, and φₘₙ representing the phase that the radiation picks up during the propagation through the aperture 108. In the example of FIG. 1, the aperture 108 is not filled with transparent material. However, it should be appreciated that in other embodiments, each of the plurality of apertures may be filled with transparent material. For example, a first layer of transparent material may be disposed in the first openings of the plurality of apertures on a first surface 103 of the layer 101 (e.g., on the ingoing opening of the aperture 108) and a second layer of the transparent material may be disposed on the second openings of the plurality of apertures on a second surface 105 of the layer 101 (e.g., in the outgoing opening of the aperture 108).

The factor Aₘₙ may be invariant with respect to rotations around the center of the waveguide lens. If the waveguide lens is small (e.g., compared to the distances to the point source 102 and to the focus point 106), the variation of Aₘₙ with m and n for equally sized waveguides may be assumed to be small and not affect the phase of the radiation. It is thus not calculated if the waveguide lens is small.

The third propagation part,

$$\frac{i {e}^{- i ω {t}_{3} + {ikr}_{mn}^{′}}}{2 π {r}_{mn}^{′}} k \times {\int }_{{S}_{mn}} n \times E ( {x}^{″} ) {e}^{- ik \cdot {x}^{″}} {da}^{″} ,$$

may describe the propagation from the waveguide to the focus point 106 as a vector equation in the Fraunhofer approximation. The Fraunhofer approximation may be good for points many wavelengths away from the diffracting system and far away regarding the dimension of the diffracting system itself. In this respect, the diffracting system may identified with each aperture of the waveguide lens and not with the whole waveguide lens. The integral may describe the contributions of all electric fields in the outgoing opening of the aperture 108 with k=k (x/r), x having the components (x,y,z) and r being the length of x. Sₘₙ may be the surface of the outgoing opening of the aperture 108 and n may be a unit vector that is normal to the surface Sₘₙ in the direction of the focus point 106.

Formula 1 may exclude multiple propagation through the aperture 108 caused by back-scattering on the surfaces when the radiation reaches the exits of the aperture 108, propagation by more than one waveguide mode or by more than two waveguide modes that have both the lowest energy, and contributions from decaying radiation with a frequency below the cutoff frequency of the aperture 108.

More specifically, radiation entering the aperture 108 from the point source 102 and propagating to the other end of the aperture 108 may be scattered back at the surface of the aperture 108 instead of exiting the aperture 108 to continue propagating to the focus point 106. When the back-scattered radiation reaches again the entry side of the aperture 108, it may exit the aperture 108 and be lost for contribution to the focus point 106 or it may be back-scattered again to propagate to the other end of the aperture 108. If such radiation then leaves the aperture 108, it may have picked up an additional phase that is not considered in Formula 1. Back-scattering may be reduced when there is no additional material interface between the aperture 108 and the space to which the aperture 108 couples.

A material interface may be formed using different materials inside and outside the aperture 108. In other words, if the space before and after the aperture 108 is empty (e.g., consists only of air), then the internal of the aperture 108 may also be empty and consist only of air. If there is a layer of transparent material before and after the aperture 108, this material may be the same before and after the aperture 108 and this material may also be located inside the aperture 108.

Excluding the propagation of the radiation by more than one waveguide mode or by more than two waveguide modes that have both the lowest energy may be achieved with a high accuracy by selecting the aperture 108 in such a way that the cutoff frequency of the aperture 108 (e.g., the cutoff frequency of the lowest waveguide mode) is equal to or below the frequency of the radiation but that the next higher modes have a cutoff frequency that is above the frequency of the radiation. In this case, apertures with a certain extension (e.g., more than one wavelength of the radiation in free space) should be dominated by propagation in the lowest waveguide mode. Increasing the extension (e.g., length) of the aperture 108 may further reduce the relevance of higher waveguide modes. This may also be true for suppressing contributions from radiation decaying inside the aperture 108, such as radiation below the cutoff frequency of the lowest waveguide mode. Apertures with a certain extension (e.g., more than one wavelength of the radiation in free space) may suppress such radiation that decays exponentially inside of the aperture 108.

In embodiments, the second propagation part through the aperture 108 may be calculated with the assumption that the frequency of the radiation is equal to or above the cutoff frequency of a square waveguide but below the frequency of the next higher waveguide mode. Thus, the radiation may propagate only in the lowest mode with an electric field either in the x-direction or in the y-direction. Higher modes may be neglected, especially if the waveguide has a certain extension in the z-direction (e.g., an extension that is more than one wavelength). In other embodiments, the apertures may be implemented in such a way that higher waveguide modes contribute to the radiation of a specific frequency. If higher waveguide modes contribute to the radiation of a specific frequency, the radiation may pick up different phases in the different waveguide modes and the interference pattern may be more complex.

To calculate the second propagation part through the aperture 108 with the assumption that the frequency of the radiation is equal to or above the cutoff frequency of a square waveguide but below the frequency of the next higher waveguide mode, it may be assumed that the electric field is in the x-direction, the center of the waveguide is at x″=0=y″, and the waveguide starts at z″=0. Thus, the electric field of the lowest waveguide mode may be described by:

$${E}_{LWG} ( {x}^{″} , t ) = {e}_{x} {E}_{LWG} {e}^{{ik}^{″} {z}^{″} - i ω t} sin ( \frac{π {y}^{″}}{a} + \frac{π}{2} ) θ ( \frac{a}{2} - abs ( {y}^{″} ) ) \qquad Formula 2$$

$$where {k}^{″} = \frac{2 π}{λ} \sqrt{1 - {( \frac{λ}{{λ}_{c}} )}^{2}} = k \sqrt{1 - {( \frac{λ}{{λ}_{c}} )}^{2}} ,$$

λ is the wavelength of the radiation outside the waveguide, λ_{c}=2a represents the cutoff wavelength that relates to the cutoff frequency of the waveguide by λ_{c}=2πc/ω_{c}, a represents the side length of the square aperture 108, θ(x) is the step function that is equal to zero if the argument is less than zero and equal to 1 if the argument is equal to zero or larger than zero, and abs is the absolute value function applied to a number or a vector (in which case it is the same as the length of the vector). A wavelength λ that is equal to λ_{c} may cause complete freezing of the phase of the radiation inside of the aperture 108.

Formula 2 for the lowest waveguide mode may assume that the radiation arriving at the aperture 108 has only a component in the x-direction (as shown in FIG. 1) that will then couple only to the lowest waveguide mode with the electric field in the x-direction. If the radiation arriving at the aperture 108 has also a component in y-direction it will couple to the other lowest waveguide mode that has an electric field in y-direction and varies in x-direction. This other lowest waveguide mode may be obtained from the above expression by replacing x with y and y with x. Radiation with an electric field in x- and y-direction may independently propagate in the lowest waveguide mode for the electric field in x-direction and in the lowest waveguide mode for the electric field in y-direction (the two modes having the same cutoff frequency for a square aperture). After propagation through the waveguide, the electric field of the two modes may recombine at the end of the waveguide to radiation with an electric field in x- and y-direction.

In embodiments, the waveguide lens of the system 100 may be a small waveguide lens. A small waveguide lens may be a waveguide lens that has a size (e.g., radius) that is small compared to the distances p and p′ (e.g., the distances between the waveguide lens and the point source 102 and its image at the focus point 106). With this approximation and the solution of the waveguide propagation in the lowest mode, the third propagation part may be described by:

$$\begin{matrix}\frac{{ie}^{{ikr}_{mn}^{′}}}{2 π {r}_{mn}^{′}} k \times {\int }_{{S}_{mn}} n \times E ( {x}^{″} ) {e}^{- ik \cdot {x}^{″}} {da}^{″} \\ = k \times {e}_{y} \frac{{iE}_{LWG} {e}^{{ikr}_{mn}^{′}}}{2 π {r}_{mn}^{′}} {\int }_{- \frac{a}{2}}^{\frac{a}{2}} {dx}^{″} {e}^{- ik \frac{{xx}^{″}}{z}} {\int }_{- \frac{a}{2}}^{\frac{a}{2}} {dy}^{″} {e}^{- ik \frac{{yy}^{″}}{z}} sin ( \frac{π {y}^{″}}{a} + \frac{π}{2} ) \\ = k \times {e}_{y} \frac{{iE}_{LWG} {e}^{{ikr}_{mn}^{′}}}{2 π {r}_{mn}^{′}} \frac{{a}^{2}}{2} sin c ( \frac{kax}{2 z} ) ( sin c ( \frac{kay}{2 z} + \frac{π}{2} ) + sin c ( \frac{kay}{2 z} - \frac{π}{2} ) ) \\ = k \times {e}_{y} \frac{{iE}_{LWG} {e}^{{ikr}_{mn}^{′}}}{2 π {r}_{mn}^{′}} \frac{{a}^{2}}{2} sin c ( \frac{{πλ}_{c} x}{2 λ z} ) ( sin c \frac{( {πλ}_{c} y}{2 λ z} + \frac{π}{2} ) + sin c ( \frac{{πλ}_{c} y}{2 λ z} - \frac{π}{2} ) )\end{matrix} \qquad Formula 3$$

with sinc(x)=sin(x)/x. Formula 3 may be obtained by approximating r by z in the expression k=k (x/r). The derivation of Formula 3 may be based on the assumption that the phase that is picked up in the aperture 108 is already contained in the term for the second portion of the path in Formula 1, so the electric field E(x″) in the integral in Formula 3 does not describe this phase (in this respect it also differs from the electric field of the lowest waveguide mode in Formula 2). This result may be similar to the diffraction of a small square aperture. For example, this result may be similar to the diffraction of a small square aperture in terms of its dependence on x.

Formula 3 shows that the contribution from a single aperture such as the aperture 108 may have a peak at the center line of the aperture (x=0=y) and may decay very slowly in the x-direction and the y-direction because for λ≈λ_{c}, the first zero is around x=±2z and y=±z. Thus, the breadth of the peak may increase proportionally to z which is assumed to be large (e.g., close to p′) and many wavelengths long. Accordingly, the dependency of the single waveguide mode on x and y to the propagation in image space may be neglected in the following.

Formula 3 may be proportional to abs (k×e_{y})=k sin θ, with θ being the angle between the vector x and the y-direction. The origin of the coordinate system may be placed at the central position of the waveguide lens. The x-direction and y-direction may be as indicated in FIG. 1 and the z-direction may be along the line between the point source 102 and the focus point 106. For large z, the angle θ may be close to π/2 so that the abs (k×e_{y})≈k. However, this approximation may break down when locations are considered that are far away from the central line going through the center of the aperture 108. Locations that are far away from the central line going through the center of the aperture 108 may be considered when contributions are considered from apertures that are far away from the central axis of the waveguide lens (e.g., from apertures from the peripheral region of a large waveguide lens in a distance that is similar to the extension of the waveguide lens).

The same calculations may be carried out for a waveguide mode that has an electric field in y-direction instead of in x-direction. Thus, a wave from the light emitter at the point source 102 that reaches the opening of the aperture 108 may have an arbitrary polarization regarding the x-direction and the y-direction. The wave can couple to a waveguide mode with an electric field in the x-direction and to a second waveguide mode with an electric field in the y-direction and propagate as a superposition of the two lowest waveguide modes. The two lowest waveguide modes may both couple again to the free space modes when they leave the aperture 108. Thus, the aperture 108 in a small waveguide lens does not change the polarization of the radiation. Because the aperture 108 in a small waveguide lens does not change the polarization of the radiation, only the electrical field strength may be considered in the following small waveguide lens description, and the vector characteristic of the electric field and its dependence on directions may be neglected.

Using the solution of the lowest waveguide mode, the phase picked up by the propagation through the waveguide may be described as:

$${φ}_{mn} = {d}_{mn} \sqrt[2]{1 - {( \frac{λ}{{λ}_{c , mn}} )}^{2}} \qquad Formula 4$$

with λ_{c,mn} being the cutoff wavelength of the square aperture 108. Thus λ_{c,mn}=2aₘₙ, and dₘₙ represents the depth of the aperture 108.

With these quantities, the electric field strength may be described as:

$$\begin{matrix}{E}_{mn} ( x - {x}_{mn} , y - {y}_{mn} , z , t ) = {E}_{0}^{′} {A}_{mn} {e}^{- i ω t} \frac{{e}^{{ikr}_{mn}}}{2 π {r}_{mn}} {e}^{ik {φ}_{mn}} \frac{{e}^{{ikr}_{mn}^{′}}}{2 π {r}_{mn}^{′}} \\ = \frac{{E}_{0}^{′} {A}_{mn} {e}^{- i ω t}}{{( 2 π )}^{2} {r}_{mn} {r}_{mn}^{′}} {e}^{ik ( {r}_{mn} + {r}_{mn} + {φ}_{mn} )} = \frac{{E}_{0}^{′} {A}_{mn} {e}^{- i ω t}}{{( 2 π )}^{2} {r}_{mn} {r}_{mn}^{′}} {e}^{i \frac{2 π}{λ} ( {r}_{mn} + {r}_{mn}^{′} + {φ}_{mn} )}\end{matrix} \qquad Formula 5$$

$$with {r}_{mn} = \sqrt[2]{{x}_{mn}^{2} + {y}_{mn}^{2} + {p}^{2}} - {d}_{mn}$$

(assuming that the changing thickness of the individual apertures is completely extending into the source space and the image space of the waveguide lens is flat) and

$${r}_{mn}^{′} = \sqrt[2]{{( x - {x}_{mn} )}^{2} + {( y - {y}_{mn} )}^{2} + {p}^{{′}^{2}} \cdot } {x}_{mn}$$

and the yₘₙ may be the coordinates of the center of the aperture 108.

The radiation intensity may be given by the absolute square of the electric field. Considering the radiation intensity in the plane that is orthogonal to the center axis and that has a distance of p′ from the waveguide lens, the radiation intensity may be described as:

$$I ( x , y , {p}^{′} , t ) = abs {( {\sum }_{m , n} {E}_{mn} ( x - {x}_{mn} , y - {y}_{mn} , {p}^{′} , t ) )}^{2} = {I}_{0} abs {( {\sum }_{m , n} \frac{{A}_{mn}}{{r}_{mn} {r}_{mn}^{′}} {e}^{i \frac{2 π}{λ} ( {r}_{mn} + {r}_{mn}^{′} + {φ}_{mn} )} )}^{2} , \qquad Formula 6$$

with abs( )² describing the absolute square of a complex quantity (e.g., the product of the complex quantity and its complex conjugate). Formula 6 may be obtained by neglecting constant phases that are common to all contributions of the sum and are thus irrelevant when the absolute value of the sum is calculated.

Assuming that p and p′ are much larger than x, xₘₙ, y, and yₘₙ and the Aₘₙ is constant (all of which may be a good approximation for waveguide lenses with a small radius compared to the distances p and p′), it follows that the radiation intensity may be described as:

$$I ( x , y , {p}^{′} , t ) = {I}_{0}^{′} abs {( {\sum }_{m , n} \frac{1}{{r}_{mn} {r}_{mn}^{′}} {e}^{i \frac{2 π}{λ} ( {r}_{mn} + {r}_{mn}^{′} + {φ}_{mn} )} )}^{2} . \qquad Formula 7$$

With the assumption that p and p′ are much larger than x, xₘₙ, y, and yₘₙ, respectively, it may be possible to make the following approximations:

$${r}_{mn} = \sqrt[2]{{x}_{mn}^{2} + {y}_{mn}^{2} + {p}^{2}} - {d}_{mn} = p {( 1 + \frac{{x}_{mn}^{2} + {y}_{mn}^{2}}{{p}^{2}} )}^{\frac{1}{2}} - {d}_{mn} \approx p + \frac{{x}_{mn}^{2} + {y}_{mn}^{2}}{2 p} - {d}_{mn} = p + \frac{{R}_{mn}^{2}}{2 p} - {d}_{mn} ; and$$

$$\begin{matrix}{r}_{mn}^{′} = \sqrt[2]{{( x - {x}_{mn} )}^{2} + {( y - {y}_{mn} )}^{2} + {p}^{{′}^{2}}} = {{p}^{′} ( 1 + \frac{{( x - {x}_{mn} )}^{2} + {( y - {y}_{mn} )}^{2}}{{p}^{{′}^{2}}} )}^{\frac{1}{2}} \\ \approx {p}^{′} + \frac{{( x - {x}_{mn} )}^{2} + {( y - {y}_{mn} )}^{2}}{2 {p}^{′}}\end{matrix}$$

$$with {R}_{mn}^{2} = {x}_{mn}^{2} + {y}_{mn}^{2} , {R}_{mn}$$

being the distance of the center of the aperture 108 to the center of the waveguide lens.

The radiation intensity at the focus point 106 may then be described as:

$$I ( 0 , 0 , {p}^{′} , t ) = {I}_{o}^{′} abs {( {\sum }_{m , n} \frac{{e}^{i \frac{2 π}{λ} ( p + {p}^{′} + \frac{{R}_{mn}^{2}}{2 f} - {d}_{mn} + {φ}_{mn} )}}{( p + \frac{{R}_{mn}^{2}}{2 p} - {d}_{mn} ) ( {p}^{′} + \frac{{R}_{mn}^{2}}{2 {p}^{′}} )} )}^{2}$$

$$with \frac{1}{f} = \frac{1}{p} + \frac{1}{p′}$$

(e.g., the thin lens formula). The common constant phase

$$\frac{2 π}{λ} ( p + {p}^{′} )$$

may be irrelevant because the absolute square of the sum over m and n is calculated. Formula 8 may be similar to the expression for photon sieves, but for photon sieves dₘₙ=0=φₘₙ, and the positions of the apertures described by Rₘₙ² may be used to obtain constructive interference.

For maximizing the constructive interference at the focus point 106, the phase differences between different paths may be a multiple of the wavelength 2T (or the path differences a multiple of 2πλ). This gives the equation

$$\frac{2 π}{λ} ( p + {p}^{′} + \frac{{R}_{mn}^{2}}{2 f} - {d}_{mn} + {φ}_{mn} - p - {p}^{′} + {d}_{00} - {φ}_{00} ) = 2 π l with$$

l=0, 1, 2, 3, . . . . In this expression, the path through the aperture 108 with m=0=n has been subtracted to obtain the phase differences, but such constant phases do not contribute to the absolute square and can be deleted. The above equation may simplify to

$$\begin{matrix}\frac{{R}_{mn}^{2}}{2 f} - {d}_{mn} + {φ}_{mn} = l λ , and with {φ}_{mn} = \\ {d}_{mn} \sqrt[2]{1 - {( \frac{λ}{{λ}_{c , mn}} )}^{2}} ,\end{matrix}$$

it follows that:

$${d}_{mn} = \frac{( \frac{{R}_{mn}^{2}}{2 f} - l λ )}{1 - \sqrt[2]{1 - {( \frac{λ}{{λ}_{c , mn}} )}^{2}}} \qquad Formula 9$$

This may be a fundamental result for the small waveguide lens because it provides a description as to how to construct an embodiment of the small waveguide lens: depending on the position of each of the plurality of apertures represented by Rₘₙ² and the cutoff wavelength of each of the plurality of apertures represented by λ_{c,mn}=2aₘₙ, the extension of the aperture in the z-direction (i.e. thickness, depth) is varied as specified in Formula 9. In an embodiment, all the apertures may have the same cross section (e.g., a square cross section with side length a). In the example of FIG. 1, λ_{c,mn}=2a. Formula 9 may be used to specify the variation in thickness of the small waveguide lens and the total thickness of the small waveguide lens may be changed by adding a constant thickness value that is effective for all apertures of the lens.

This result shows that the thickness of an aperture increases quadratically with the distance of the aperture from the center of the layer 101. If the term

$$\frac{{R}_{mn}^{2}}{2 f}$$

becomes greater than λ, it may be possible to subtract one λ from the term and use the above formula for dₘₙ. In this way, it may be possible to have a discontinuous cross section of the waveguide lens or discontinuous thickness (e.g., just like a classical Fresnel lens) and avoid an increase of the length of the apertures beyond a certain limit. The limit of increase may be given by

$$\frac{λ}{1 - \sqrt[2]{1 - {( \frac{λ}{{λ}_{c , mn}} )}^{2}}} .$$

Calculating the focal length f from formula 9 gives

$$f = \frac{{R}_{mn}^{2}}{2 ( l λ + {d}_{mn} ( 1 - \sqrt[2]{1 - {( \frac{λ}{{λ}_{c , mn}} )}^{2}} ) )} .$$

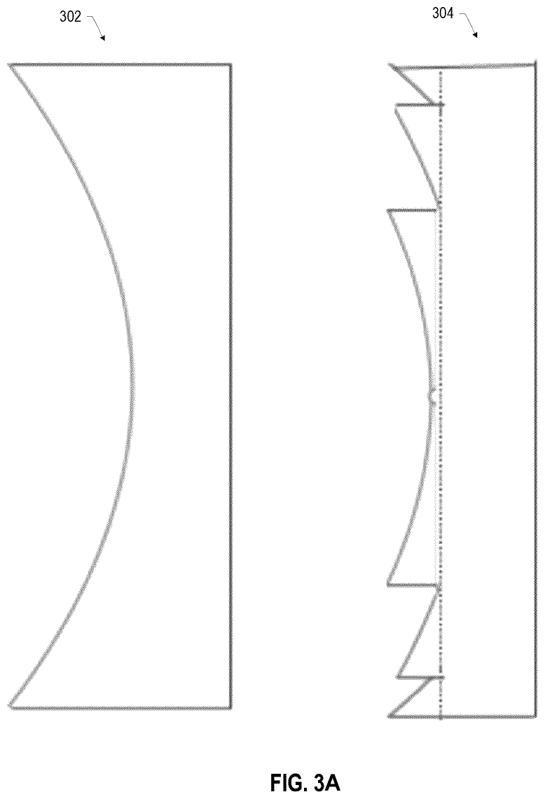

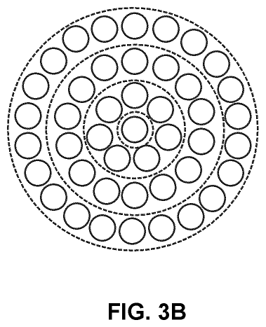

For the case of a continuously increasing thickness of the small waveguide lens from the center to the edge (see e.g. waveguide lens with cross section 302 in FIG. 3) and a constant cutoff wavelength Aₑ for all apertures, the focal length may be expressed in the following way

$${f}_{cont} = \frac{{D}^{2}}{2 d ( 1 - \sqrt[2]{1 - {( \frac{λ}{{λ}_{c}} )}^{2}} )} ,$$

with D being the diameter of the small waveguide lens and d the thickness at the edge. From the focal length f follows the dependence between p and p′ through

$$\frac{1}{f} = \frac{1}{p} + \frac{1}{p′} .$$

For the case of a discontinuous thickness of the small waveguide lens to limit the maximal thickness increase to the smallest value possible by subtracting the value lλ in formula 9 when possible (see e.g. waveguide lens with cross section 304 in FIG. 3), the focal length may be approximated in the following way

$${f}_{discount} \approx \frac{{D}^{2}}{2 L λ} ,$$

with L being the number of discontinuities of the depth of the small waveguide lens and Lλ being assumed to be much larger than

$${d}_{mn} ( 1 - \sqrt[2]{1 - {( \frac{λ}{{λ}_{c , mn}} )}^{2}} ) ,$$

With the terms for f_{cont} and f_{discont}, it may be possible to design small waveguide lenses with the desired focal length for the two cases of continuous thickness and of discontinuous thickness to limit the thickness increase to the smallest value possible.

In one embodiment, all the apertures may be square apertures with the same side length so that the apertures maybe arranged regularly and as close together as technically possible. The minimal thickness of the apertures may be selected independently of interference considerations, as any overall phase contribution may be irrelevant. The minimal thickness may be selected so that radiation below the cutoff frequency (e.g., above the cutoff wavelength) has decayed sufficiently inside the waveguide and that higher waveguide modes may be neglected. The minimal thickness may be selected so that extraordinary optical transmission, which may be caused by coupled surface plasmon excitations and which should be reduced with the increasing thickness, may be neglected.

In embodiments, it may be possible to vary the cutoff wavelength by varying the side length of the square apertures depending on given aperture depths dₘₙ. The corresponding formula for maximal constructive interference may be described as:

$${λ}_{c , mn} = \frac{λ}{\sqrt[2]{1 - {( 1 + \frac{l λ - \frac{{R}_{mn}^{2}}{2 f}}{{d}_{mn}} )}^{2}}} . \qquad Formula 10$$

In an embodiment, all of the apertures may have the same length dₘₙ=doo. The square cross sections may then have a side length aₘₙ=λ_{c,mn}/2.

The results for the small waveguide lens have been calculated for apertures with perfectly conducting walls. In real metals that may not be able to completely exclude an electric field inside the metal and that may also have additional charges inside the metal, the effective cutoff frequency may be different and the results for the depth and the cutoff frequencies of the apertures may be also different. The skilled person will know how to adjust the above results (or the following results including the results for the large waveguide lens) to real metals such as silver, gold, copper, or aluminum.

Using Formula 7, it may be possible to calculate the resolution of the small waveguide lens in a further approximation for the maximal interference case (using φₘₙ=lλ−rₘₙ−r′ₘₙ (x=0, y=0)):

$$I ( x , y , {p}^{′} , t ) = {I}_{o}^{′} abs {( {\sum }_{m , n} \frac{{e}^{i \frac{2 π}{2 λ {p}^{′}} ( {( x - {x}_{mn} )}^{2} + {( y - {y}_{mn} )}^{2} - {x}_{mn}^{2} - {y}_{mn}^{2} )}}{( p + \frac{{R}_{mn}^{2}}{2 p} - {d}_{mn} ) ( {p}^{′} + \frac{{( x - {x}_{mn} )}^{2} + {( y - {y}_{mn} )}^{2}}{2 {p}^{′}} )} )}^{2} .$$

For x, y<<xₘₙ, yₘₙ (which is good for investigating the peak close to the focus point 106), the approximations

$$\begin{matrix}{( x - {x}_{mn} )}^{2} = {{x}_{mn}^{2} ( 1 - \frac{x}{{x}_{mn}} )}^{2} \approx {x}_{mn}^{2} - 2 {xx}_{mn} and {( y - {y}_{mn} )}^{2} = {{y}_{mn}^{2} ( 1 - \frac{y}{{y}_{mn}} )}^{2} \approx \\ {y}_{mn}^{2} - 2 {yy}_{mn}\end{matrix}$$

may be utilized, along with p>>Rₘₙ² and p′ (x−xₘₙ)²+(y−yₘₙ)², to generate the following result:

$$I ( x , y , {p}^{′} , t ) = {I}_{o}^{′} abs {( {\sum }_{m , n} \frac{{e}^{- i \frac{2 π}{λ p} ( {xx}_{mn} + {yy}_{mn} )}}{{pp}^{′}} )}^{2} .$$

For infinitesimal apertures, the sum may be calculated exactly as an integral for a rectangular waveguide lens with side length L to be

$$I ( x , y , {p}^{′} , t ) \to {I}_{o}^{″} abs {( {\int }_{\frac{L}{2}}^{\frac{L}{2}} {dx}^{′} {e}^{- i \frac{2 π}{λ {p}^{′}} {xx}^{′}} {\int }_{\frac{L}{2}}^{\frac{L}{2}} {dy}^{′} {e}^{- i \frac{2 π}{λ {p}^{′}} {yy}^{′}} )}^{2} = {I}_{0}^{″} {L}^{4} sin {c}^{2} ( \frac{π L}{{p}^{′} λ} x ) sin {c}^{2} ( \frac{π L}{{p}^{′} λ} y ) .$$

Thus, the spot may be limited to abs(x)<p′λ/L and abs(y)<p′λ/L. In other words, the spot size may be smaller than λ for p′/L<1, at which point the approximation may not be reliable anymore as far as peripheral waveguides are concerned.

In embodiments, the waveguide lens may be circular. If the waveguide lens is circular, the integral may give the standard expression of the radiation intensity for the diffraction spot of a round aperture:

$${I}_{round} ( x , y , {p}^{′} , t ) \to {I}_{roun} abs {( \frac{{J}_{1} ( \frac{2 π R}{λ p} ρ )}{\frac{2 π R}{λ {p}^{′}} ρ} )}^{2} ,$$

with J₁ being the first Bessel function of the first kind, R being the radius of the waveguide lens, and p

$$\begin{matrix}ρ = \\ \sqrt[2]{{x}^{2} + {y}^{2}} .\end{matrix}$$

This result may be a standard result of a lens with a round aperture that focuses at the focus point 106.

The small waveguide lens may have a resolution that is proportional to the extension of the layer 101. The resolution may be inversely proportional to the focal distance and the wavelength λ. This is the same result as for the diffraction of an aperture of the same size as the waveguide lens considered here. Using again the formula I(x′, y′, p′, t) for describing the intensity in point (x′, y′,p′) and extending it for a light emitter that is located at (x, y, p), it follows that:

$${I}_{x , y} ( {x}^{′} , {y}^{′} , {p}^{′} , t ) = abs {( {\sum }_{m , n} {D}_{mn} {e}^{i \frac{2 π}{λ} ( {r}_{mn} + {r}_{mn}^{′} + {φ}_{mn} )} )}^{2} ,$$

with Dₘₙ describing the real part of the individual contributions, and

$$\begin{matrix}{r}_{mn} = \sqrt[2]{{( x - {x}_{mn} )}^{2} + {( y - {y}_{mn} )}^{2} + {p}^{2}} - {d}_{mn} \\ {r}_{m n}^{′} = \sqrt[2]{{( {x}^{′} - {x}_{mn} )}^{2} + {( {y}^{′} - {y}_{mn} )}^{2} + {p}^{{′}^{2}}} .\end{matrix}$$

The maximal interference condition at x′=y′=0 for a light emitter at x=y=0 may give

$$\begin{matrix}{φ}_{mn} = \\ l λ - {r}_{mn} ( x = 0 , y = 0 ) - {r}_{mn}^{′} ( {x}^{′} = 0 , {y}^{′} = 0 ) \approx l λ - p - {p}^{′} - \frac{{R}_{mn}^{2}}{2 f} + {d}_{mn} .\end{matrix}$$

Ignoring common phases in the following calculations, it may follow that:

$${I}_{x , y} ( {x}^{′} , {y}^{′} , {p}^{′} , t ) = abs {( {\sum }_{m , n} {D}_{mn} {e}^{i \frac{2 π}{λ} ( {r}_{mn} + {r}_{mn}^{′} - \frac{{R}_{mn}^{2}}{2 f} + {d}_{mn} )} )}^{2} ,$$

If the absolute values of p and p′ are much larger than the absolute values of x, xₘₙ, y, and yₘₙ, respectively, the following approximations may be made:

$$\begin{matrix}{r}_{mn} \approx p + \frac{{( x - {x}_{mn} )}^{2} + {( y - {y}_{mn} )}^{2}}{2 p} - {d}_{mn} ; and \\ {r}_{mn}^{′} \approx {p}^{′} + \frac{{( {x}^{′} - {x}_{mn} )}^{2} + {( {y}^{′} - {y}_{mn} )}^{2}}{2 {p}^{′}}\end{matrix}$$

These approximations may be used to arrive at:

$${I}_{x , y} ( {x}^{′} , {y}^{′} , {p}^{′} , t ) = abs {( {\sum }_{m , n} {D}_{mn} {e}^{i \frac{2 π}{λ} ( \frac{{( x - {x}_{mn} )}^{2} + {( y - {y}_{mn} )}^{2} - {R}_{mn}^{2}}{2 p} + \frac{{( x′ - {x}_{mn} )}^{2} + {( y′ - {y}_{mn} )}^{2} - {R}_{mn}^{2}}{2 p ′} )} )}^{2} .$$

This may give for an abs(xₘₙ) that is much larger than abs(x) and an abs(yₘₙ) that is much larger than abs(y)

$${I}_{x , y} ( {x}^{′} , {y}^{′} , {p}^{′} , t ) = abs ( {\sum }_{m , n} {D}_{mn} {e}^{{i \frac{2 π}{λ pp′} ( {x}_{mn} ( {xp}^{′} + {x}^{′} p ) + {y}_{mm} ( {yp}^{′} + {y}^{′} p ) ) )}^{2} .}$$

So, there is constructive interference for all apertures for

$${x}^{′} = - \frac{{p}^{′}}{p} x and {y}^{′} = - \frac{p′}{p} y$$

for a light emitter that is not located on the central axis of the small waveguide lens.

Thus, the small waveguide lens forms, for a light emitter at distance p from the lens and position (x, y), a point of maximum interference at distance p′ from the lens and position

$$( - \frac{{p}^{′}}{p} x , - \frac{p ′}{p} y ) ,$$

when the lens also forms for a light emitter at distance p from the lens and position (0,0) a point of maximum interference at distance p′ from the lens and position (0,0). Thus, the small waveguide lens has a focal plane that is parallel to the waveguide lens and light emitters in this focal plane have a point of maximal interference in a corresponding image plane that is also parallel to the waveguide lens. The distance of the point of maximum constructive interference from the central axis may be increased by a factor of

$$\frac{{p}^{′}}{p}$$

compared to the distance of the light emitter in the focal plane from the central axis.

In embodiments, the waveguide lens of the system 100 may be a large waveguide lens. A large waveguide lens may be a waveguide lens that has a size (e.g., radius) that may be comparable to or larger than the distances p and p′. For the large waveguide lens, the distances between the aperture 108 and the point source 102 and its image at P′ may be large compared to the wavelength of the radiation. With this approximation, the third propagation part becomes, for the square aperture 108 with side length a:

$$\begin{matrix}\frac{{ie}^{{ikr}_{mn}^{′}}}{2 π {r}_{mn}^{′}} k \times {\int }_{{S}_{mn}} n \times E ( {x}^{″} ) {e}^{- ik \cdot {x}^{″}} {da}^{″} \\ = k \times {e}_{y} \frac{{iE}_{LWG} {e}^{{ikr}_{mn}^{′}}}{2 π {r}_{mn}^{′}} \frac{{a}^{2}}{2} sin c ( \frac{{πλ}_{c} x}{2 λ r} ) ( sin c ( \frac{{πλ}_{c} y}{2 λ r} + \frac{π}{2} ) + sin c ( \frac{{πλ}_{c} y}{2 λ r} - \frac{π}{2} ) ) ,\end{matrix}$$

$$with$$

$$\begin{matrix}{r}_{mn}^{′} = \sqrt[2]{{x}_{mn}^{2} + {y}_{mn}^{2} + {p}^{{′}^{2}}} \\ r = \sqrt[2]{{x}^{2} + {y}^{2} + {z}^{2}} .\end{matrix}$$

This expression is similar to the corresponding expression for the small waveguide lens, but with z replaced by r. For

$$\frac{{λ}_{c}}{2} \leq λ \leq {λ}_{c}$$

and using abs(x)≤r, it is

$$\frac{π {λ}_{c} abs ( x )}{2 λ r} \leq π ,$$

so that

$$sin c ( \frac{π {λ}_{c} x}{2 λ r} ) \geq 0$$

for x≥0 and also for x≤0 (in which case the sine function and the denominator change their sign). The second term may be rewritten as:

$$\begin{matrix}sin c ( \frac{π {λ}_{c} y}{2 λ r} + \frac{π}{2} ) + sin c ( \frac{{πλ}_{c} y}{2 λ r} - \frac{π}{2} ) = π cos c ( \frac{{πλ}_{c} abs ( y )}{2 λ r} ) , with cos c ( x ) = \\ cos ( x ) / ( {( \frac{π}{2} )}^{2} - {x}^{2} ) . For \frac{{π}_{c}}{2} \leq λ \leq {λ}_{c}\end{matrix}$$

and using

$$abs ( y ) \leq r , it is \frac{π {λ}_{c} abs ( y )}{2 λ r} \leq π ,$$

so that

$$\begin{matrix}cos c ( \frac{{πλ}_{c} y}{2 λ r} ) > \\ 0.\end{matrix}$$

The result for the third propagation part, calculated for the square aperture 108 with side length a may be described as:

$${A}_{mn}^{′} = sin c ( \frac{{πλ}_{c , mn} y}{2 λ r} + \frac{π}{2} ) + sin c ( \frac{{πλ}_{c , mn} y}{2 λ r} - \frac{π}{2} ) )$$

so that all contributions from the integral to the third propagation part are positive and thus interfere constructively. Thus, the terms A′ₘₙ may be neglected when calculating interference of different radiation paths for which the phase of the radiation is relevant.

The electric field strength of radiation may become, for the large waveguide lens:

$${E}_{mn} ( x - {x}_{mn} , y - {y}_{mn} , z , t ) = \frac{{E}_{0}^{′} {A}_{mn} {A}_{mn}^{′} {e}^{- i ω t}}{{( 2 π )}^{2} {r}_{mn} {r}_{mn}^{′}} {e}^{i \frac{2 π}{λ} ( {r}_{mn} + {r}_{mn}^{′} + {φ}_{mn} )}$$

$$with$$

$$\begin{matrix}{r}_{mn} = \sqrt[2]{{x}_{mn}^{2} + {y}_{mn}^{2} + {( p - {d}_{mn} )}^{2} ,} \\ {r}_{mn} = \sqrt[2]{{( x - {x}_{mn} )}^{2} + {( y - {y}_{mn} )}^{2} + {p}^{{′}^{2}}} , \\ {φ}_{mn} = {d}_{mn} \sqrt[2]{1 - {( \frac{λ}{{λ}_{c , mn}} )}^{2}} .\end{matrix}$$

This result may neglect the dependence of the contribution at the focal point 106 on the direction from which the radiation comes (e.g., through which aperture the radiation propagated) based on the vector property of the electric field. Radiation coming from apertures close to the center of the lens may nearly contribute with the full strength. Radiation coming from apertures far away from the center of the lens may nearly contribute in full strength if the radiation is polarized in the x-direction, if the radiation comes from an aperture close to the y-axis of the lens, or if the radiation is polarized in the y-direction and the radiation comes from an aperture close to the x-axis of the lens. By contrast, radiation that is polarized in x-direction and comes from a waveguide far away from the y-axis of the lens or radiation that is polarized in y-direction and it comes from a waveguide far away from the x-axis of the lens may contribute substantially less than with the full field strength because the vector of the electric field may not be aligned with the vector of the sum of all radiation contributions and the angle between them will increase with the distance of the aperture in the respective direction. The vector property of the electric field of all these contributions may not affect the phase of the radiation so that it may be neglected when considering conditions for constructive interference.

Before calculating the conditions for constructive interference of the large waveguide lens, the coupling Aₘₙ of the radiation emitted from the point source 102 to the waveguide mode may be investigated. The coupling may be calculated based on the overlap Bₘₙ of the two waves at the interface Tₘₙ (e.g., the opening of a square aperture with side length a to the point source side) as follows:

$${B}_{mn} = {C}_{mn} {\int }_{{T}_{mn}} \frac{{e}^{- ik \cdot r″}}{r″} sin ( \frac{π {y}^{″}}{a} + \frac{π}{2} ) θ ( \frac{a}{2} - abs ( {y}^{″} ) ) {da}^{″} .$$

This expression is for radiation that is polarized in x-direction. The term Cₘₙ may reflect the vector property of the electric field and how this modifies the result may depend on the position of the aperture 108 in the x-direction and in the y-direction. The term Bₘₙ may describe the coupling of radiation from P that is polarized in the x-direction to the waveguide mode that is also polarized in x-direction. Thus, if the aperture 108 is close to the y-axis of the lens, then the radiation from P may be very close to the vector ex (and thus aligned with the respective waveguide mode) and the coupling may be hardly reduced due to the vector property of the electric field. If the aperture 108 is far away from the y-axis of the lens, the radiation from P may have a component in the z-direction, and the component in the x-direction may be reduced. Thus, the vector of the electric field may not be aligned with the vector of the waveguide mode and the angle between the two vectors may increase with the distance of the aperture 108 from the y-axis of the lens, resulting in a reduction of the coupling expressed by Cₘₙ. The factor Cₘₙ may be approximated to be

$${C}_{m n} = \sqrt[2]{1 - {( \frac{{x}_{m n}}{{r}_{m n}} )}^{2}} ,$$

assuming that the center of the waveguide lens is at x=0=y and xₘₙ is the x-coordinate of the center of the aperture 108. As this term is always positive, it may neglected in the calculation of the conditions for constructive interference.

The integral in the expression for Bₘₙ may be similar to the integral calculated for the coupling of the waveguide mode to the wave propagating to the focus point 106. This may occur because the circumstances are similar and only the direction of the propagation is reversed.

Taking into account the contribution of the electric field of the radiation propagating along the path of the radiation from the point source 102 to the focus point 106 (e.g., in the three propagation parts), the coupling Aₘₙ may be assumed to be calculated by:

$${A}_{m n} = {C}_{m n} {\int }_{\frac{{a}_{m n}}{2}}^{\frac{{a}_{m n}}{2}} {dx}^{″} {e}^{- i k \frac{{x}_{mn} {x}^{″}}{{r}_{m n}}} {\int }_{\frac{{a}_{m n}}{2}}^{\frac{{a}_{m n}}{2}} {dy}^{″} {e}^{- i k \frac{{y}_{m n} {y}^{″}}{{r}_{m n}}} sin ( \frac{π {y}^{″}}{a} + \frac{π}{2} ) = {C}_{m n} \frac{{a}_{m n}^{2}}{2} sinc ( \frac{π {λ}_{c , mn} {x}_{mn}}{2 λ {r}_{m n}} ) ( sinc ( \frac{π {λ}_{c , mn} {y}_{m n}}{2 λ {r}_{m n}} + \frac{π}{2} ) + sinc ( \frac{π {λ}_{c , mn} {y}_{m n}}{2 λ {r}_{m n}} - \frac{π}{2} ) )$$

with the approximation

$${r}^{″} = abs ( {x}_{m n} + {x}^{″} ) \approx abs ( {x}_{m n} ) + \frac{{x}_{m n} {x}^{″}}{abs ( {x}_{m n} )} + \frac{{y}_{m n} {y}^{″}}{abs ( {x}_{m n} )} = {r}_{m n} + \frac{{x}_{m n} {x}^{″}}{{r}_{m n}} + \frac{{y}_{m n} {y}^{″}}{{r}_{m n}} .$$

As has been shown above for a similar expression, for

$$\frac{{λ}_{c , mn}}{2} \leq λ \leq {λ}_{c , mn}$$

and using abs(xₘₙ)≤rₘₙ, it is

$$\frac{π {λ}_{c , mn} abs ( {x}_{m n} )}{2 λ {r}_{m n}} \leq π ,$$

so that sinc

$$( \frac{π {λ}_{c , mn} {x}_{mn}}{2 λ {r}_{m n}} ) \geq 0$$

for xₘₙ≥0 and xₘₙ≤0. Also, for abs(yₘₙ)≤rₘₙ, it is

$$\frac{π {λ}_{c , mn} abs ( {y}_{m n} )}{2 λ {r}_{m n}} \leq π ,$$

so that

$$cosc ( \frac{π {λ}_{c , mn} {y}_{m n}}{2 λ {r}_{m n}} ) > 0 ( it is sinc ( \frac{π {λ}_{c , mn} {y}_{m n}}{2 λ {r}_{m n}} + \frac{π}{2} ) + sinc ( \frac{π {λ}_{c , mn} {y}_{m n}}{2 λ {r}_{m n}} - \frac{π}{2} ) = π cosc ( \frac{π {λ}_{c , mn} {y}_{m n}}{2 λ {r}_{m n}} ) ) .$$

Thus, the coupling Aₘₙ may always be positive and may be neglected when calculating the conditions for constructive interference for,

$$\frac{{λ}_{c , mn}}{2} \leq λ \leq {λ}_{c , mn} .$$

The intensity at the focus point 106 can thus be described as:

$$I ( 0 , 0 , {p}^{′} , t ) = {I}_{0}^{′} {abs ( {\sum }_{m , n} \frac{{I}_{m n} {e}^{i \frac{2 π}{λ} ( {r}_{m n} + {r}_{mn}^{′} + {φ}_{m n} )}}{{r}_{m n} {r}_{mn}^{′}} )}^{2}$$

$$with$$

$${r}_{m n} = \sqrt[2]{{x}_{m n}^{2} + {y}_{m n}^{2} + {( p - {d}_{m n} )}^{2}} = \sqrt[2]{{R}_{m n}^{2} + {( p - {d}_{m n} )}^{2}}$$

$${r}_{mn}^{′} = \sqrt[2]{{x}_{m n}^{2} + {y}_{m n}^{2} + {p}^{′2}} = \sqrt[2]{{R}_{m n}^{2} + {p}^{′2}} ,$$

$${φ}_{m n} = {d}_{mn} \sqrt[2]{1 - {( \frac{λ}{{λ}_{c , mn}} )}^{2}} , and$$

$${I}_{m n} \geq 0 ,$$

$$using {R}_{m n}^{2} = {x}_{m n}^{2} + {y}_{m n}^{2} , {R}_{m n}$$

being the distance of the center of the aperture 108 to the center of the waveguide lens.

The term dₘₙ may be expected to be much smaller than the macroscopic quantities

$${R}_{m n}^{2}$$

and p because it is in the order of a wavelength (see the calculation for the small waveguide lens described above). For this reason, the following approximation can be made to simplify the expression for I(0,0, p′, t):

$${r}_{m n} = \sqrt[2]{{R}_{m n}^{2} + {( p - {d}_{m n} )}^{2}} = \sqrt[2]{{R}_{m n}^{2} + {p}^{2} - 2 p {d}_{m n} + {d}_{m n}^{2}} = \sqrt[2]{{R}_{m n}^{2} + {p}^{2}} \sqrt[2]{1 + \frac{- 2 p {d}_{m n} + {d}_{m n}^{2}}{{R}_{m n}^{2} + {p}^{2}}} \approx \sqrt[2]{{R}_{m n}^{2} + {p}^{2}} - \frac{p}{\sqrt[2]{{R}_{m n}^{2} + {p}^{2}}} {d}_{m n} .$$

With this, it follows from the requirement of constructive interference

$$\frac{2 π}{λ} ( \sqrt[2]{{R}_{m n}^{2} + {p}^{2}} - \frac{p}{\sqrt[2]{{R}_{m n}^{2} + {p}^{2}}} {d}_{m n} + \sqrt[2]{{R}_{m n}^{2} + {p}^{′2}} + {d}_{m n} \sqrt[2]{1 - {( \frac{λ}{{λ}_{c , mn}} )}^{2}} ) = 2 π l ,$$

with l=1, 2, 3, . . . . From this follows:

$${d}_{mn} = \frac{\sqrt[2]{{R}_{mn}^{2} + {p}^{2}} + \sqrt[2]{{R}_{mn}^{2} + {p}^{′2}} - l λ}{\frac{p}{\sqrt[2]{{R}_{mn}^{2} + {p}^{2}}} - \sqrt[2]{1 - {( \frac{λ}{{λ}_{c , mn}} )}^{2}}} . \qquad Formula 11$$

This result for the large waveguide lens has been obtained for

$$\frac{{λ}_{c , mn}}{2} \leq λ \leq {λ}_{c , mn} .$$

For λ<λ_{c,mn}/2, there may be negative contributions from certain apertures that are far away from the center of the large waveguide lens. This result for the large waveguide lens reproduces the result for the small waveguide lens for

$${R}_{mn}^{2} ≪ {p}^{2} and {R}_{mn}^{2} ≪ {p}^{{′}^{2}}$$

up to a constant value which has been subtracted for the small waveguide lens when considering the phase differences. A result for dₘₙ may be obtained without using the above approximation for rₘₙ. This result allows for the construction of a large waveguide lens with square apertures of potentially varying side lengths aₘₙ (which determines λ_{c,mn} by λ_{c,mn}=2aₘₙ) and a depth dₘₙ of the apertures.

The thickness of the large waveguide lens as described in formula 11 may be very large because it is approximately proportional to p+p′. As a consequence, the thickness described in formula 11 may be changed by subtracting a constant value from all apertures of the waveguide lens because only phase differences may be relevant. In other words, formula 11 may describe the thickness variation of the waveguide lens and not the total thickness.

In an embodiment, the thickness of Formula 11 may be reduced by subtracting the depth value of the aperture in the center of the lens (setting l to zero there) and adding a constant thickness value:

$$\begin{matrix}{d}_{mn}^{′} = {d}_{mn} - {d}_{00} + {d}_{constant} \\ = \frac{\sqrt[2]{{R}_{mn}^{2} + {p}^{2}} + \sqrt[2]{{R}_{mn}^{2} + {p}^{{′}^{2}}} - l λ}{\frac{p}{\sqrt[2]{{R}_{mn}^{2} + {p}^{2}}} - \sqrt[2]{1 - {( \frac{λ}{{λ}_{c , mn}} )}^{2}}} - \frac{p + {p}^{′}}{1 - \sqrt[2]{1 - {( \frac{λ}{{λ}_{c , mn}} )}^{2}}} + {d}_{constant} .\end{matrix} \qquad Formula 12$$

So, the total thickness of a large waveguide lens as specified in formula 12 may have the value d_{constant} at the center and increase continuously or discontinuously from there.

The term

$$\frac{p}{\sqrt[2]{{R}_{mn}^{2} + {p}^{2}}} - \sqrt[2]{1 - {( \frac{λ}{{λ}_{c , mn}} )}^{2}}$$

in formulas 11 and 12 may become negative for some combinations of p,

$${R}_{mn}^{2} ,$$

λ, and λ_{c,mn} but this may be avoided by e.g. selecting d_{constant} in formula 12 accordingly or by subtracting the most negative value of all dₘₙ from all dₘₙ so that all dₘₙ become positive.

In different embodiments, the thickness described by formula 11 may be changed by subtracting (or adding) different constant thickness values from dₘₙ to obtain different total thickness values for the apertures of the large waveguide lens. For a total thickness values based on formula 11, the relationship between p and p′ may be determined to design a large waveguide lens so that a certain value of p′ is obtained for a given value of p. As an example, p′ depends on p in formula 11 in the following way:

$${p}^{′} = \sqrt{{( {d}_{mn} ( \frac{p}{\sqrt[2]{{R}_{mn}^{2} + {p}^{2}}} - \sqrt[2]{1 - {( \frac{λ}{{λ}_{c , mn}} )}^{2}} ) + l λ - \sqrt[2]{{R}_{mn}^{2} + {p}^{2}} )}^{2} - {R}_{mn}^{2}} .$$

From this expression, p′ may be obtained for the large waveguide lens with continuous thickness and a constant cutoff wavelength λ_{c} for all apertures to give

$${p}_{cont}^{′} = \sqrt{{( d ( \frac{p}{\sqrt[2]{{D}^{2} + {p}^{2}}} - \sqrt[2]{1 - {( \frac{λ}{{λ}_{c}} )}^{2}} ) - \sqrt[2]{{D}^{2} + {p}^{2}} )}^{2} - {D}^{2}} ,$$

with D being the diameter of the small waveguide lens and d the thickness at the edge.

For the case of a discontinuous thickness of the large waveguide lens to limit the maximal thickness increase to the smallest value possible by subtracting the value lλ in formula 11 when possible,

$${p}_{discont}^{′}$$

may be approximated in the following way

$${p}_{discont}^{′} = \sqrt{{( L λ - \sqrt[2]{{D}^{2} + {p}^{2}} )}^{2} - {D}^{2}} ,$$

with L being the number of discontinuities of the depth of the large waveguide lens and Lλ being assumed to be much larger than

$${d}_{mn} ( 1 - \sqrt[2]{1 - {( \frac{λ}{{λ}_{c m n}} )}^{2}} ) ,$$

In embodiments, all of the apertures may have the same side length aₘₙ=a. If all of the apertures may have the same side length, the cutoff wavelength λ_{c} may be equal to the predetermined wavelength λ. For such an embodiment, the radiation may not pick up any phase when it propagates through the apertures.

In embodiments, the depth dₘₙ of the apertures may be limited by increasing the value for l by one as soon as the term

$$\sqrt[2]{{R}_{mn}^{2} + {p}^{2}} + \sqrt[2]{{R}_{mn}^{2} + {p}^{{′}^{2}}}$$

becomes larger than one wavelength λ. In this manner, the depth dₘₙ of the apertures may be reduced in a discontinuous way, but the total value may be limited.

The requirement for constructive interference at the focus point 106 may be resolved with respect to λ_{c,mn} to give:

$${λ}_{c , mn} = \frac{λ}{\sqrt[2]{1 - {( \frac{p}{\sqrt[2]{{R}_{mn}^{2} + {p}^{2}}} + \frac{l λ - \sqrt[2]{{R}_{mn}^{2} + {p}^{2}} - \sqrt[2]{{R}_{mn}^{2} + {p}^{{′}^{2}}}}{{d}_{mn}} )}^{2}}} . \qquad Formula 13$$

This result allows the construction of a large waveguide lens with a given depth of square apertures of dₘₙ and a varying side length aₘₙ=λ_{c,mn}/2. In an embodiment, all the apertures may have the same depth dₘₙ=d.

In embodiments of a waveguide lens having square apertures with different or equal side lengths, the features or geometric characteristics (e.g., depth and cross section) of each aperture may be determined based on the requirement of maximum constructive interference. In other embodiments, the requirement of maximum constructive interference may be used to determine the features of each aperture even if the propagation is represented in a different way. Thus, other embodiments of a waveguide lens may easily be constructed even if a different calculation is used for the propagation of the radiation.

In other embodiments, the apertures may be round and may be arranged evenly and/or symmetrically spaced on concentric circles around the central axis of the waveguide lens. With a symmetrical arrangement, contributions from the same circle of waveguides that deviate from the rotational symmetry may cancel each other. For example, an aperture above the center of the waveguide lens may be paired with an aperture of the same depth and aperture size at the same distance below the center of the waveguide lens.

Generally, the more peripheral apertures may be considered to couple less efficiently to the radiation from the light source. The solid angle of the peripheral apertures may be smaller with respect to the light emitter placed on the central axis of the waveguide lens. Conversely, the peripheral apertures may be important for the resolution of the waveguide lens so that the cross section of the apertures may be increased for apertures that are further away from the central axis of the waveguide lens. In one embodiment, the increase may be limited so that no additional waveguide modes contribute to the propagation of the radiation through the aperture. In some embodiments, one or more waveguide modes may contribute to the propagation and the number of contributing waveguide modes may increase for larger apertures. The thickness of the apertures may be adjusted to different sizes to optimize the interference at the focus point 106. Such an increase of cross section of more peripheral apertures may be implemented for square or round apertures. In some embodiments, the cross section of more peripheral apertures may be reduced.

In embodiments, the resolution may be increased by increasing the size of the waveguide lens. The size of the lens may be similar to or greater than the distance of the point source 102 to the waveguide lens or the distance of the focus point 106 to the lens.

In a further embodiment, the apertures may be rectangular so that only radiation of a certain polarization can pass the waveguide lens.

The light from the point source 102 may be a coherent light source. The light may be of a specific wavelength. Different wavelengths may possibly not be focused at the focus point 106. In embodiments, the waveguide lens may have two or three or more different types of apertures that are implemented in such a way that they focus two or three or more specific wavelengths at the same focus point 106 or at two or three or more different focus points, respectively.

The different types of apertures may be filled with a color filter material that passes radiation of the wavelength that the aperture can shape to interfere constructively at the respective focus point and that blocks radiation of a wavelength range that the aperture cannot shape to interfere constructively at the respective focus point. For example, the waveguide lens may have three different types of apertures. The first type may shape red light of a specific wavelength to focus at the focus point 106 and may be filled with a red color filter material that passes as much red light of the specific wavelength as possible and blocks as much light with a different wavelength as possible. The second type may shape green light of a specific wavelength to focus at the focus point 106 and may be filled with a green color filter material that passes as much green light of the specific wavelength as possible and blocks as much light with a different wavelength as possible. The third type may shape blue light of a specific wavelength to focus at the focus point 106 and may be filled with a blue color filter material that passes as much blue light of the specific wavelength as possible and blocks as much light with a different wavelength as possible. The different types of apertures may be arranged symmetrically around the central axis of the waveguide lens. Such a waveguide lens may be able to focus light of the visible spectrum that comprises red, green, and blue light in one focus point.

As mentioned above, the apertures may be filled with transparent material in which case, the cutoff wavelength λ_{c,mn}=2 a_{c,mn} may be the cutoff wavelength in the material (e.g., not in vacuum or in air). Thus, the aperture cross section may be further reduced. If the aperture cross section may be further reduced, a layer of the same transparent material may be added to one or both surfaces of the waveguide lens in order to protect the waveguide lens. The requirements for maximum constructive interference may have to take into account such changes that affect the propagation of the radiation from the point source 102 to the focus point 106.

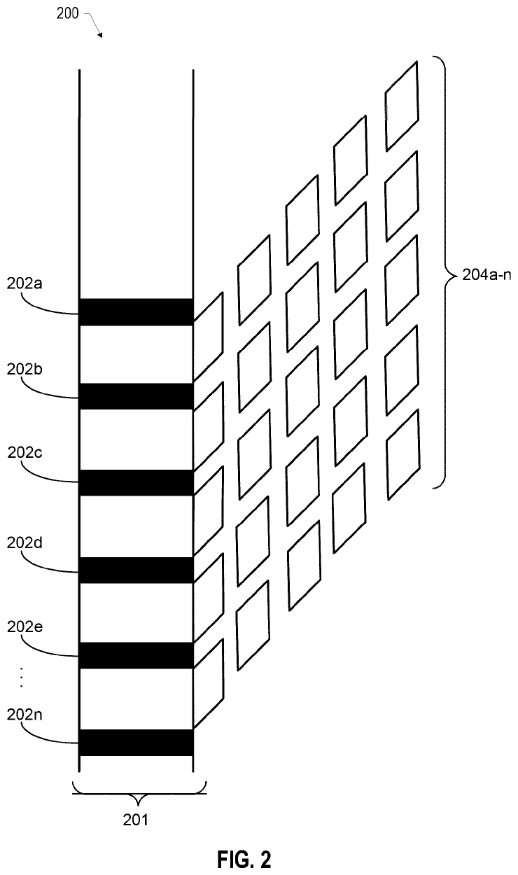

FIG. 2 shows an example waveguide lens 200. The waveguide lens 200 may be used in accordance with the system 100, described above with regard to FIG. 1. The waveguide lens 200 may comprise a layer 201. The layer 201 may be made of material that is opaque to radiation. The layer 201 may comprise conductive walls formed in the layer for each of the apertures disposed in the layer 201. The conductive walls may comprise or may be made of silver, gold, copper, aluminum, or another metal. The layer 201 may comprise a conductive plate. For example, the layer 201 may comprise a metal plate that may comprises or may be made of silver, gold, copper, or aluminum.

The waveguide lens 200 may comprise a plurality of apertures 204a-n disposed in the layer 201. The material 202a to 202n between the plurality of apertures 204a-n may be opaque to radiation so that radiation may only pass through the layer 201 by passing through the plurality of apertures 204a-n. For example, each of the plurality of apertures 204a-n may comprise conductive walls formed in the layer 201. Each of the plurality of apertures 204a-n may have geometric characteristics for controlling a phase of radiation propagating through that particular aperture. Each of the plurality of apertures 204a-n in the layer may control the phase of the radiation that emanates from a light emitter and propagates through the aperture. For example, each of the plurality of apertures 204a-n in the layer may control the phase of the radiation that propagates through the aperture based on a location of the aperture in the layer 201. Each of the plurality of apertures 204a-n in the layer 201 may control the phase of the radiation that propagates through that aperture to form a predetermined interference pattern after the radiation has propagated through the aperture. The predetermined interference pattern may be constructive interference at a first predetermined point (e.g., location) for a light emitter at a second predetermined point.

The radiation that emanates from the light emitter may comprise coherent radiation. The radiation that emanates from the light emitter may have one frequency and/or may come from one location. The phrase “one location” may refer to a region having a small extension with respect to the distance between the light emitter and the lens. The one location may be far away (e.g., close to infinity). The one location may be any size, including a large size. The radiation may comprise one or more of microwave radiation, infrared radiation, visible light, ultraviolet light, extreme ultraviolet light, soft gamma radiation, or radiation in a range between any combination thereof.

In embodiments, the geometric characteristics of each of the plurality of apertures 204a-n comprise one or more of a cross-section size and a depth. The phase of radiation propagating through a particular aperture of the plurality of apertures 204a-n may be controlled by adjusting the depth of the aperture and/or the side length (e.g., cross section-size) of the aperture. The cross-section size of each aperture may control the wavelength of the radiation that propagates through the aperture. The depth of each aperture may control how long the radiation propagates through the aperture. Each of the plurality of apertures 204a-n may have different depths and the same size of cross sections, different sizes of cross sections and the same depth, or different depths and different sizes of cross sections.

Each of the plurality of apertures 204a-n may comprise a square or rectangular cross section. If each of the plurality of apertures 204a-n comprise a square or rectangular cross section, the geometric characteristics may comprise a side length of the cross section and a depth of the aperture. Each of the plurality of apertures 204a-n may comprise a circular cross section, an oval cross section, or a polygonal cross section with more than four line segments. If each of the plurality of apertures 204a-n comprise a circular cross section, an oval cross section, or a polygonal cross section with more than four line segments, the geometric characteristics may comprise a radius of the cross section and a depth of the aperture.

In embodiments, each of the plurality of apertures 204a-n have a square cross section and a cutoff wavelength that is twice a side length of the cross section. If each of the plurality of apertures 204a-n have a square cross section and a cutoff wavelength that is twice a side length of the cross section, the depth dₘₙ of each of the plurality of apertures 204a-n may be related to a cutoff frequency λ_{c,mn} of the aperture and a location of the aperture approximately in the following way:

$${d}_{mn} = \frac{( \frac{{R}_{mn}^{2}}{2 f} - l λ )}{1 - \sqrt[2]{1 - {( \frac{λ}{{λ}_{c , mn}} )}^{2}}} ,$$

wherein Rₘₙ is the distance of the aperture to a central axis of the lens,

$$\frac{1}{f} = \frac{1}{p} + \frac{1}{{p}^{′}}$$

with p being a distance from the light emitter on a central axis of the lens to a front surface of the layer 201 and p′ being a distance of a point of constructive interference on a central axis of the lens to the back surface of the layer 201, A is the wavelength of the radiation, and l is a positive integer including zero. The depth of each aperture may always increase with the distance of the aperture to the central axis of the lens or the depth of each of the plurality of apertures 204a-n may increase in one or more ranges with the distance of the aperture to the central axis of the lens and may decrease at one or more distances of the aperture to the central axis of the lens.

In embodiments, each of the plurality of apertures 204a-n may be a waveguide for the radiation. A size of a cross section of each of the plurality of apertures 204a-n may be configured to provide a cutoff frequency so that incident radiation with a frequency below the cutoff frequency is attenuated inside the aperture and incident radiation with a frequency above the cutoff frequency propagates through the aperture. For example, radiation with a frequency below the cutoff frequency may be attenuated inside the aperture by decaying exponentially as it proceeds inside the aperture. Incident radiation with a frequency above the cutoff frequency may propagates through the aperture by coupling to one or more propagating modes inside the aperture. The cutoff frequency that is equal to a frequency of a lowest propagating waveguide mode may be equal to or less than a frequency of the radiation emanating from the light emitter. The frequency of a second lowest propagating waveguide mode may be greater than the frequency of the radiation emanating from the light emitter.

In embodiments, each of the plurality of apertures 204a-n may be filled with transparent material. For example, a first layer of the transparent material may be disposed on the first openings of each of the plurality of apertures 204a-n on the first surface of the layer 201. A second layer of the transparent material may be disposed on the second openings of each of the plurality of apertures 204a-n on the second surface of the layer 201.

In embodiments, at least two apertures of the plurality of apertures 204a-n may be filled with a first color filter material. The first color filter material may be configured to pass radiation in a first wavelength range and block radiation outside the first wavelength range. At least one additional, such as two additional, apertures of the plurality of apertures 204a-n may be filled with a second color filter material that is configured to pass radiation in a second wavelength range and block radiation outside the second wavelength range.

FIG. 3A shows an example cross section of a waveguide lens, in accordance with various embodiments. A waveguide lens may have a thickness that at least partially continuously increases with distance from the center of the waveguide lens. For example, a waveguide lens comprising a plurality of apertures of constant side length may have a thickness that at least partially continuously increases with distance from the center of the waveguide lens. As shown in the example of FIG. 3A, a waveguide lens may have a cross section 302. A waveguide lens having the cross section 302 may have a thickness that always increases quadratically with distances from the center of the waveguide lens. A waveguide lens may have a cross section 304. A waveguide lens having the cross section 304 may have a thickness that continuously increases in one or more ranges with distance of the aperture to the central axis and decreases at one or more distances in a way that may be considered as discontinuous. In other words, the thickness varies according to a step function that is dependent on distance from the center of the waveguide lens. The discontinuous decreases in thickness of the layer of the waveguide lens may be selected so that the depth increase of the apertures is limited to the smallest possible value. In other words, every time a phase difference of radiation going through an aperture becomes larger than 2π compared to any one of the more centrally located apertures, the depth of the aperture is reduced and not increased. It should be appreciated that in other embodiments, a waveguide lens may have a cross section other than the cross section 302 or the cross section 304. This may concern the increase of the thickness of the layer of the waveguide lens or the minimal thickness of the thickness that may represent an offset for all apertures of the layer. The non-planar surface may face the light emitter and the planar surface the image area such as the focus point or the other way around. In a different embodiment, both surfaces of the waveguide lens may be non-planar.

A waveguide lens such as illustrated in FIG. 3A may be fabricated using standard techniques that are also used to fabricate Fresnel zone plates. Such techniques may include photo lithography, electron beam lithography, focused ion beam lithography, inductively coupled plasma dry etching, other integrated circuit manufacturing technologies, laser ablation techniques for structuring metal layer surfaces, or a combination of such techniques. A waveguide lens may be fabricated by first producing a metal layer with a desired cross sectional profile and then add the apertures to the metal layer. In a different embodiment, a waveguide lens may be fabricated by producing a layer made of non-metallic material with apertures and then coat the aperture walls and optionally also the top of layer with a metal.

FIG. 3B is a top view of a central portion of a waveguide lens according to an embodiment. The apertures have a circular shape or cross section and are arranged in circles around the center of the waveguide lens. The thickness of the waveguide lens increases stepwise for each new circle in which the apertures are arranged at least for the portion shown in FIG. 3B. In this figure, the apertures are represented as circular lines and the increases of thickness are represented as circular broken lines. In an embodiment, the increase in thickness may continue for the complete waveguide lens. In a different embodiment, the thickness may decrease from one circle to the next circle when the phase difference at a relevant point (.e.g a focus point) to radiation going through a more centrally located aperture becomes larger than a certain value such as 2π. In a different embodiment, the apertures of FIG. 3B may be replaced with apertures of a different shape such as a square shape or cross section. The waveguide lens of FIG. 3B may have a layer that comprises or is made of a metal that is highly conductive such as silver, gold, copper. In a different embodiment of FIG. 3B, the waveguides of the apertures may comprise a core of a first material and a cladding of a second material that surrounds the sidewalls of the core. The first material may have a lower refractive index than the second material so that the radiation undergoes internal reflection when propagating through the core of an aperture. In FIG. 3B, the full circular lines may represent the outer boundaries of the cladding and the material between the cladding may be a third material that is opaque to the radiation.

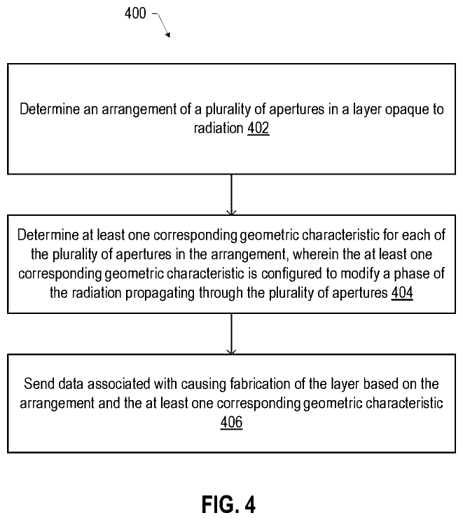

FIG. 4 is a flow diagram of an exemplary method 400 of manufacturing a waveguide lens, in accordance with various embodiments. The method 400 may be used in any suitable setting to perform any suitable support operations. Operations are illustrated once each and in a particular order in FIG. 4, but the operations may be reordered and/or repeated as desired and appropriate (e.g., different operations performed may be performed in parallel, as suitable).

At 402, an arrangement of a plurality of apertures may be determined. The arrangement may be an arrangement of the plurality of apertures to be formed in a layer opaque to radiation. The layer opaque to radiation may comprise a conductive plate. For example, the layer opaque to radiation may comprise a metal plate.

Geometric characteristic for each of the plurality of apertures may be determined (e.g., selected). At 404, at least one corresponding geometric characteristic for each of the plurality of apertures in the arrangement may be determined (e.g., selected). The at least one corresponding geometric characteristic may be configured to modify a phase of the radiation propagating through the plurality of apertures. For example, each of the plurality of apertures may control the phase of the radiation that emanates from a light emitter and propagates through the aperture. Each of the plurality of apertures in the layer may control the phase of the radiation that propagates through the aperture based on a location of the aperture in the arrangement. The geometric characteristics for each of the plurality of apertures may be selected so that each aperture controls the phase of the radiation that propagates through the aperture to form a predetermined interference pattern after the radiation has propagated through the aperture. The predetermined interference pattern may be constructive interference at a first predetermined point (e.g., location) for a light emitter at a second predetermined point.

At 406, data associated with causing fabrication of the layer based on the arrangement and the at least one corresponding geometric characteristic may be sent. Sending the data may comprise sending the data to a machine configured to fabricate the layer based on the arrangement and the at least one corresponding geometric characteristic.

The disclosure may include any combination of the following aspects:

In the above detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the detailed description is not to betaken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

1. A lens comprising:
a layer of material that is opaque to radiation; and
a plurality of apertures disposed in the layer, each of the plurality of apertures having geometric characteristics for controlling a phase of radiation propagating through the aperture and each of the plurality of apertures comprising a waveguide for the radiation with a size of a cross section that is configured to provide a cutoff frequency so that incident radiation with a frequency below the cutoff frequency is attenuated inside the aperture and incident radiation with a frequency above the cutoff frequency propagates through the aperture,
wherein each of the plurality of apertures in the layer controls the phase of the radiation that emanates from a light emitter and propagates through the aperture, based on a location of the aperture in the layer, to form a predetermined interference pattern after the radiation has propagated through the aperture.

2. The lens of claim 1, wherein the predetermined interference pattern comprises constructive interference at a predetermined point for a light emitter at a predetermined point.

3. The lens of any one of claims 1-2, wherein the radiation that emanates from the light emitter is coherent radiation that has one frequency and comes from one location.

4. The lens of any one of claims 1-3, wherein incident radiation with a frequency below the cutoff frequency is attenuated inside the aperture by decaying exponentially as it proceeds inside the aperture and incident radiation with a frequency above the cutoff frequency propagates through the aperture by coupling to one or more propagating modes inside the aperture.

5. The lens of any one of claims 1-4, wherein the cutoff frequency that is equal to a frequency of a lowest propagating waveguide mode is equal to or less than a frequency of the radiation emanating from the light emitter and a frequency of a second lowest propagating waveguide mode is greater than the frequency of the radiation emanating from the light emitter.

6. The lens of any one of claims 1-5, wherein the geometric characteristics comprise a size of a cross section and a depth of each aperture of the plurality of apertures, and wherein the size of the cross section of each aperture controls the wavelength of the radiation that propagates through the aperture and the depth of each aperture controls how long the radiation propagates through the aperture.

7. The lens of claim 6, wherein the apertures of the plurality of apertures have different depths and the same size of cross sections, different sizes of cross sections and the same depth, or different depths and different sizes of cross sections.

8. The lens of any one of claims 1-7, wherein the phase of the radiation propagating through the aperture is controlled by increasing the phase velocity of the radiation inside the aperture.

9. The lens of any one of claims 1-8, wherein each of the plurality of apertures has conductive walls formed in the layer.

10. The lens of claim 9, wherein the layer is a conductive plate.

11. The lens of any one of claims 9-10, wherein the conductive walls comprise or are made of silver, gold, copper, or aluminum.

12. The lens of any one of claims 1-11, wherein each of the plurality of apertures have a square or rectangular cross section and the geometric characteristics comprise a side length of the cross section and a depth of the aperture or wherein each of the plurality of apertures have a circular cross section, an oval cross section, or a polygonal cross section with more than four line segments and the geometric characteristics comprise a radius of the cross section and a depth of the aperture.

13. The lens of any one of claims 1-12, wherein each of the plurality of apertures have a square cross section and a cutoff wavelength that is twice a side length of the cross section and the depth dₘₙ of each aperture aₘₙ is related to a cutoff frequency λ_{c,mn} of the aperture aₘₙ and a location of the aperture aₘₙ approximately in the following way
$${d}_{mn} = \frac{( \frac{{R}_{mn}^{2}}{2 f} - l λ )}{1 - \sqrt[2]{1 - {( \frac{λ}{{λ}_{c , mn}} )}^{2}}} ,$$
wherein Rₘₙ is the distance of the aperture aₘₙ to a central axis of the lens,
$$\frac{1}{f} = \frac{1}{p} + \frac{1}{{p}^{′}}$$
with p being a distance of the light emitter on a central axis of the lens to a front surface of the lens and p′ being a distance of a point of constructive interference on a central axis of the lens to the back surface of the lens, λ is the wavelength of the radiation, and l is a positive integer.

14. The lens of claim 13, wherein the depth of each aperture always increases with the distance of the aperture to the central axis of the lens or the depth of each aperture increases in one or more ranges with the distance of the aperture to the central axis of the lens and decreases at one or more distances of the aperture to the central axis of the lens.

15. The lens of any one of claims 1-14, wherein each of the plurality of apertures is filled with transparent material.

16. The lens of claim 15, wherein a first layer of the transparent material is disposed on the first openings of the plurality of apertures on the first surface of the layer of material that is opaque to the radiation and a second layer of the transparent material is disposed on the second openings of the plurality of apertures on the second surface of the layer of material that is opaque to the radiation.

17. The lens of any one of claims 1-14, wherein at least two apertures of the plurality of apertures are filled with a first color filter material that is configured to pass radiation in a first wavelength range and block radiation outside the first wavelength range and at least two further apertures of the plurality of apertures are filled with a second color filter material that is configured to pass radiation in a second wavelength range and block radiation outside the second wavelength range.

18. The lens of any one of claims 1-8, wherein the waveguides of the plurality of apertures comprise a core of a first material and a cladding of a second material that surrounds the sidewalls of the core, the first material having a lower refractive index than the second material.

19. The lens of any one of claims 1-18, wherein the radiation is microwave radiation, infrared radiation, visible light, ultraviolet light, extreme ultraviolet light, soft gamma radiation, or radiation in a range between one of them.

20. A method comprising:
determining an arrangement of a plurality of apertures in a layer of material that is opaque to radiation; and
determining at least one corresponding geometric characteristic for each of the plurality of apertures in the arrangement, wherein the at least one corresponding geometric characteristic is configured to control a phase of the radiation propagating through the plurality of apertures,
wherein each of the plurality of apertures in the layer controls the phase of the radiation that emanates from a light emitter and propagates through the aperture, based on a location of the aperture in the layer, to form a predetermined interference pattern after the radiation has propagated through the aperture and each of the plurality of apertures comprises a waveguide for the radiation with a size of a cross section that is configured to provide a cutoff frequency so that incident radiation with a frequency below the cutoff frequency is attenuated inside the aperture and incident radiation with a frequency above the cutoff frequency propagates through the aperture; and
sending data associated with causing fabrication of the layer based on the arrangement and the at least one corresponding geometric characteristic.

21. The method of claim 20, wherein sending the data comprises sending the data to a machine configured to fabricate the layer based on the arrangement and the at least one corresponding geometric characteristic.

22. A system comprising:
a coherent light source configured to output radiation; and
a waveguide lens comprising:
a layer of material that is opaque to the radiation; and
a plurality of apertures disposed in the layer, each of the plurality of apertures having
corresponding geometric characteristics for modifying a phase of the radiation propagating through the plurality of apertures,
wherein each of the plurality of apertures in the layer controls the phase of the radiation that emanates from a light emitter and propagates through the aperture, based on a location of the aperture in the layer, to form a predetermined interference pattern after the radiation has propagated through the aperture and each of the plurality of apertures comprising a waveguide for the radiation with a size of a cross section that is configured to provide a cutoff frequency so that incident radiation with a frequency below the cutoff frequency is attenuated inside the aperture and incident radiation with a frequency above the cutoff frequency propagates through the aperture.
